(19) United States
(12) Patent Application Publication
(10) Pub. No.: US 2019/0292975 A1
(43) Pub. Date: Sep. 26, 2019

(54) HYDRAULIC FAN ARRANGEMENT

(71) Applicant: Oshkosh Corporation, Oshkosh, WI (US)

(72) Inventors: Yanming Hou, Oshkosh, WI (US); Loren G. DeVries, Oshkosh, WI (US); Rongjun Zhang, Oshkosh, WI (US)

(73) Assignee: Oshkosh Corporation, Oshkosh, WI (US)

(21) Appl. No.: 16/358,193

(22) Filed: Mar. 19, 2019

Related U.S. Application Data
(60) Provisional application No. 62/645,626, filed on Mar. 20, 2018.

(51) Int. Cl. F01P 7/04; B60K 11/02; F01P 5/04; B60H 1/00

(52) U.S. Cl. CPC F01P 7/044; B60H 1/0045; F01P 5/04; B60K 11/02

(57) ABSTRACT

A vehicle includes a chassis, tractive elements configured to support the chassis, a primary driver configured to output mechanical energy to at least one of the tractive elements to drive the vehicle, a coolant circuit, a fan assembly, and a controller. The coolant circuit includes a thermal energy interface configured to transfer thermal energy from the primary driver to coolant and a radiator configured to receive the coolant. The fan assembly includes a hydraulic pump coupled to the primary driver, a hydraulic motor fluidly coupled to the hydraulic pump, a fan coupled to the hydraulic motor and configured to provide air flow to the radiator, and an actuator configured to vary a displacement of at least one of the hydraulic pump and the hydraulic motor. The controller is configured to control the actuator to vary a speed of the fan based on telematics data.

### CROSS-REFERENCE TO RELATED PATENT APPLICATION

This application claims the benefit of U.S. Provisional Patent Application No. 62/645,626, filed Mar. 20, 2018, which is incorporated herein by reference in its entirety.

### BACKGROUND

Vehicles employing internal combustion engines typically include a cooling system that circulates coolant through the engine, reducing the engine temperature. The coolant passes through a cooler (e.g., a radiator), and a fan driven by the engine forces air through the cooler to reduce the temperature of the coolant. The fan is typically driven through a mechanical clutch that is connected to the engine shaft (e.g., directly, through a power take-off shaft or driving belt). In most systems, these clutches can only be engaged (i.e., in an “on” state, fixing the fan to the engine shaft) or disengaged (i.e., in an “off” state, allowing free movement between the driving shaft of the engine and the fan). Typically, the clutch is engaged when there is a cooling demand. With the clutch engaged, the speed of the fan is entirely dependent on the speed of the engine. Accordingly, clutches provide a limited ability to adjust the speed of the fan.

### SUMMARY

One exemplary embodiment relates to a vehicle including a chassis, a series of tractive elements configured to support the chassis, a primary driver configured to output mechanical energy to at least one of the tractive elements to drive the vehicle, a coolant circuit, a fan assembly, and a controller. The coolant circuit includes a thermal energy interface configured to facilitate transfer of thermal energy from the primary driver to coolant and a radiator fluidly coupled to the thermal energy interface and configured to receive the coolant. The fan assembly includes a hydraulic pump coupled to the primary driver, a hydraulic motor fluidly coupled to the hydraulic pump, a fan coupled to the hydraulic motor and configured to provide air flow to the radiator, and an actuator configured to vary a displacement of at least one of the hydraulic pump and the hydraulic motor. The controller is operatively coupled to the actuator and configured to control the actuator to vary a speed of the fan based on telematics data.

Another exemplary embodiment relates to a fan assembly for a vehicle. The fan assembly includes a hydraulic pump configured to be coupled to a primary driver of the vehicle, a hydraulic motor fluidly coupled to the hydraulic pump, a fan coupled to the hydraulic motor and configured to provide air flow to a radiator of the vehicle, an actuator configured to vary at least one of (a) a flow rate of fluid to the hydraulic motor and (b) a displacement of the hydraulic motor, and a controller operatively coupled to the actuator. The controller is configured to control the actuator to vary a speed of the fan. The controller is configured to receive data relating to a location of the vehicle and control the speed of the fan based on the location of the vehicle.

Another exemplary embodiment relates to a method of cooling a vehicle. The method includes receiving, from a GPS, data relating to a location of the vehicle and determining, based on the data from the GPS, whether or not the vehicle is in a reduced noise area. In response to a determination that the vehicle is in the reduced noise area, the method includes operating a motor of the vehicle at a first speed. In response to a determination that the vehicle is not in the reduced noise area, the method includes operating the motor of the vehicle at a second speed greater than the first speed. The motor is coupled to a fan such that rotation of the motor causes the fan to force air toward a radiator of the vehicle.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a vehicle, according to an exemplary embodiment;

FIG. 2 is a block diagram of a cooling system of the vehicle of FIG. 1;

FIG. 3 is a block diagram of a hydraulic circuit of the vehicle of FIG. 1;

FIG. 4 is a block diagram of a control system of the vehicle of FIG. 1; and

FIG. 5 is a graph comparing a change in engine power draw required to drive a fan and a change in air flow rate of the fan as a speed of the fan changes, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

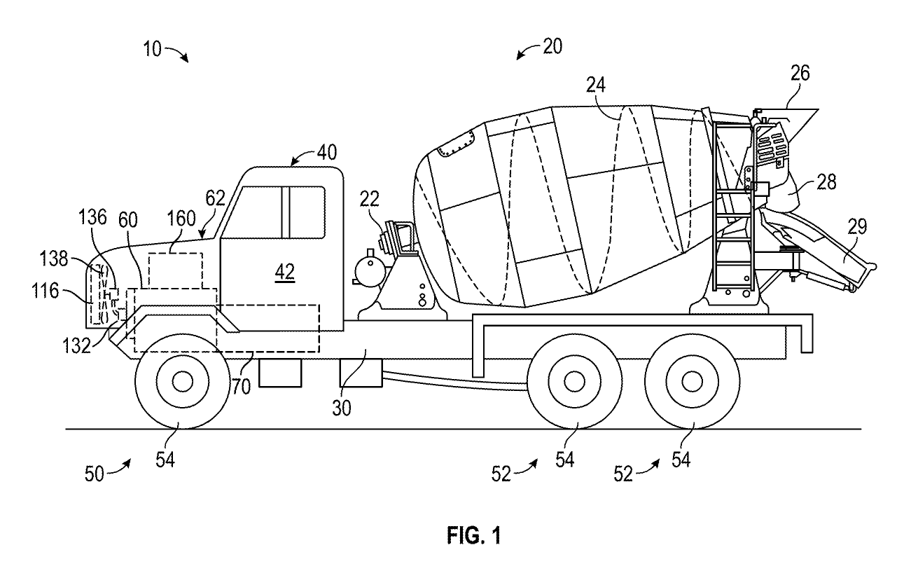

Referring to FIG. 1, a vehicle 10 is shown according to an exemplary embodiment. Specifically, the vehicle 10 is shown as a concrete mixing truck, including a drum assembly, shown as a mixing drum 20. The mixing drum 20 is configured to be rotated by a driver 22 in order to mix and dispense various materials (e.g., concrete, etc.). In the embodiment shown in FIG. 1, the vehicle 10 is configured as a rear-discharge concrete mixing truck. In other embodiments, the vehicle 10 is configured as a front-discharge concrete mixing truck. In yet other embodiments, the vehicle 10 is an off-road vehicle such as a utility task vehicle, a recreational off-highway vehicle, an all-terrain vehicle, a sport utility vehicle, and/or still another vehicle. In yet other embodiments, the vehicle 10 is another type of off-road vehicle such as mining, construction, and/or farming equipment. In still other embodiments, the vehicle 10 is an aerial truck, a rescue truck, an aircraft rescue and firefighting (ARFF) truck, a refuse truck, a commercial truck, a tanker, an ambulance, and/or still another vehicle. In yet other embodiments, the vehicle 10 is a consumer transport vehicle or public transport vehicle.

As shown in FIG. 1, the mixing drum 20 includes a mixing element (e.g., fins, etc.), shown as a mixing element 24, positioned within the interior of the mixing drum 20. The mixing element 24 may be configured to (i) mix the contents of mixture within the mixing drum 20 when the mixing drum 20 is rotated (e.g., by the driver 22) in a first direction (e.g., counterclockwise, clockwise, etc.) and (ii) drive the mixture within the mixing drum 20 out of the mixing drum 20 (e.g., through a chute, etc.) when the mixing drum 20 is rotated (e.g., by the driver 22) in an opposing second direction (e.g., clockwise, counterclockwise, etc.). The vehicle 10 also includes an inlet (e.g., hopper, etc.), shown as charge hopper 26, a connecting structure (e.g., a collector, a collection hopper, etc.), shown as discharge hopper 28, and an outlet, shown as chute 29. The charge hopper 26 is fluidly coupled with the mixing drum 20, which is fluidly coupled with the discharge hopper 28, which is fluidly coupled with the chute 29. In this way, wet or dry concrete may flow into the mixing drum 20 from the charge hopper 26 and wet concrete may flow out of the mixing drum 20 into the discharge hopper 28 and then into the chute 29 to be dispensed. According to an exemplary embodiment, the mixing drum 20 is configured to receive a mixture, such as a concrete mixture (e.g., cementitious material, aggregate, sand, rocks, etc.), through the charge hopper 26.

As shown in FIG. 1, the vehicle 10 includes a chassis, shown as frame 30. According to an exemplary embodiment, the frame 30 defines a longitudinal axis. The longitudinal axis may be generally aligned with a frame rail of the frame 30 of the vehicle 10 (e.g., front-to-back, etc.). A cab 40 is coupled to the frame 30 (e.g., at a front end thereof, etc.). The mixing drum 20 is coupled to the frame 30 and disposed behind the cab 40 (e.g., at a rear end thereof, etc.), according to the exemplary embodiment shown in FIG. 1. In other embodiments, at least a portion of the mixing drum 20 extends beyond the front of the cab 40.

According to an exemplary embodiment, the cab 40 includes one or more doors, shown as doors 42, that facilitate entering and exiting an interior of the cab 40. The interior of the cab 40 may include a plurality of seats (e.g., two, three, four, five, etc.), vehicle controls (e.g., the operator interface 250, etc.), driving components (e.g., a steering wheel, the accelerator pedal 252, the brake pedal 254, etc.), etc.

Referring again to FIG. 1, the frame 30 of the vehicle 10 engages a plurality of tractive assemblies, shown as front tractive assembly 50 and rear tractive assemblies 52. In other embodiments, the vehicle 10 includes more or fewer front tractive assemblies 50 and/or rear tractive assemblies 52. The front tractive assembly 50 and/or the rear tractive assemblies 52 may include brakes (e.g., disc brakes, drum brakes, air brakes, etc.), gear reductions, steering components, wheel hubs, wheels, tires, and/or other features. As shown in FIG. 1, the front tractive assembly 50 and the rear tractive assemblies 52 each include tractive elements, shown as wheel and tire assemblies 54, that couple the vehicle 10 to the ground and support the frame 30. In other embodiments, at least one of the front tractive assembly 50 and the rear tractive assemblies 52 include a different type of tractive element (e.g., a track, etc.).

The vehicle 10 further includes an engine, motor, or primary driver, shown as engine 60. As shown in FIG. 1, the engine 60 is coupled to the frame 30 within an engine compartment 62 defined forward of the cab 40. In other embodiments, the engine 60 may be positioned beneath the cab 40 or rearward of the cab 40. In some embodiments, the engine 60 is an internal combustion engine configured to utilize one or more of a variety of fuels (e.g., gasoline, diesel, bio-diesel, ethanol, natural gas, etc.) and output exhaust, rotational mechanical energy, and heat (e.g., due to a combustion reaction), according to various exemplary embodiments. According to an alternative embodiment, the engine 60 additionally or alternatively includes one or more electric motors coupled to the frame 30 (e.g., a hybrid vehicle, an electric vehicle, etc.). The electric motors may consume electrical power from an on-board storage device (e.g., batteries, ultra-capacitors, etc.), from an on-board generator (e.g., an internal combustion engine, etc.), and/or from an external power source (e.g., overhead power lines, etc.) and output rotational mechanical energy and heat (e.g., due to resistance within the motor).

The vehicle 10 further includes a transmission 70 that is coupled to the engine 60. The engine 60 outputs rotational mechanical energy (e.g., due to a combustion reaction, etc.) that flows into the transmission 70. The transmission 70 transfers the mechanical energy to one or more drive components (e.g., drive shafts, a transfer case assembly, etc.) that in turn transfer rotational mechanical energy to the front tractive assembly 50 and/or the rear tractive assemblies 52 to propel the vehicle 10. In one embodiment, at least a portion of the mechanical power produced by the engine 60 flows through the transmission 70 and into the front tractive assembly 50 and/or the rear tractive assemblies 52 to power at least some of the wheel and tire assemblies 54 (e.g., front wheels, rear wheels, etc.).

In an alternative embodiment, the transmission 70 may receive the mechanical energy from the engine 60 and provide an output to a generator. The generator may be configured to convert mechanical energy into electrical energy that may be stored by an energy storage device. The energy storage device may provide electrical energy to a motive driver to drive at least one of the front tractive assemblies 50 and the rear tractive assemblies 52. In some embodiments, each of the front tractive assemblies 50 and/or the rear tractive assemblies 52 include an individual motive driver (e.g., a motor that is electrically coupled to the energy storage device, etc.) configured to facilitate independently driving each of the wheel and tire assemblies 54. The powertrain of the vehicle 10 may thereby be a hybrid powertrain or a non-hybrid powertrain.

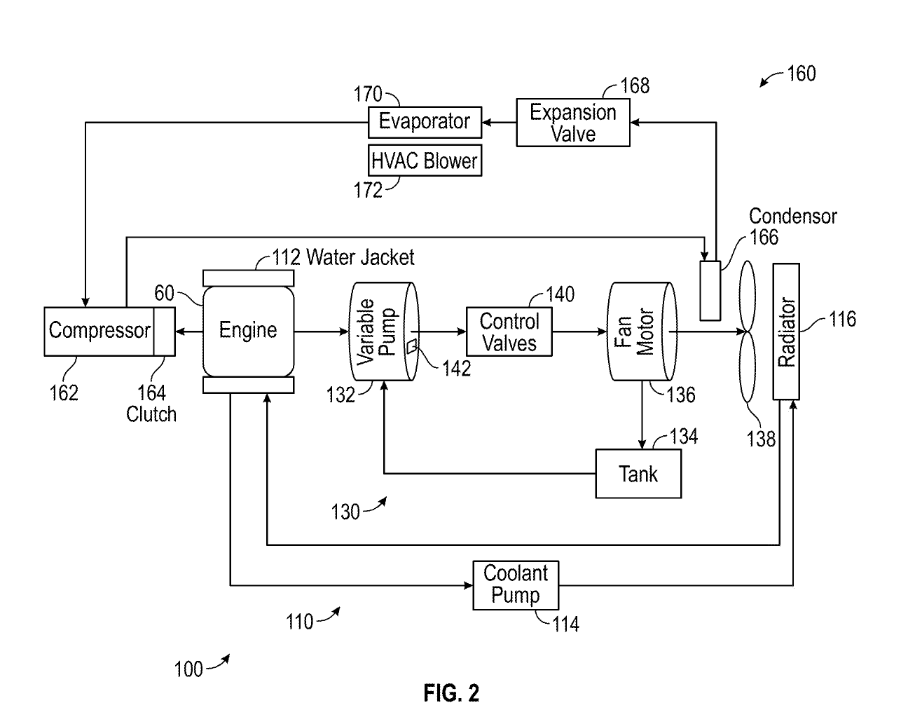

Referring to FIG. 2, the vehicle 10 further includes a temperature control system, shown as cooling system 100, configured to control the temperature of the engine 60. The temperature control system includes a coolant circuit 110 configured to absorb thermal energy from the engine 60 and transport the thermal energy to another location where it can be disseminated to the surrounding environment. Specifically, the coolant circuit 110 circulates liquid coolant therethrough, which absorbs and transports the thermal energy. The coolant circuit 110 includes a thermal energy interface, shown as water jacket 112. The water jacket 112 is thermally coupled to the engine 60 and configured to transfer thermal energy from the engine 60 into the coolant. The water jacket 112 may include a series of passages extending through the engine 60 and/or one or more sleeves or casings that surround a portion of the engine 60. A hydraulic pump, shown as coolant pump 114, is configured to pump the coolant between the water jacket 112 and a cooler, shown as radiator 116. The radiator 116 is thermally conductive and has a large surface area (e.g., formed through a number of fins, etc.). The radiator 116 is configured to transfer thermal energy from the coolant to air that comes into contact with the radiator 116. The heated air then disperses (e.g., through forced or natural convection, etc.), transferring the thermal energy to the surrounding environment.

The cooling system 100 further includes a hydraulic fan arrangement, shown as fan assembly 130. The fan assembly 130 includes a hydraulic pump, shown as hydraulic pump 132, operatively coupled to the engine 60. The hydraulic pump 132 is configured to use mechanical energy supplied by the engine 60 and provide a flow of pressurized hydraulic fluid. The hydraulic pump 132 may be directly coupled to the engine 60 (e.g., coupled to a crank shaft of the engine 60 or an output shaft of the engine 60, etc.). Alternatively, the hydraulic pump 132 may be indirectly coupled to the engine 60 through one or more power transmission devices (e.g., the transmission 70, a serpentine belt assembly, a geared connection, a power take-off, etc.). The hydraulic pump 132 is configured to receive hydraulic fluid at a relatively low pressure (e.g., atmospheric pressure, etc.) from a reservoir, shown as tank 134.

The outlet of the hydraulic pump 132 is fluidly coupled (e.g., indirectly or indirectly) to a hydraulic motor, shown as fan motor 136. Accordingly, the flow of pressurized hydraulic fluid from the hydraulic pump 132 drives the fan motor 136. After exiting the fan motor 136, the hydraulic fluid returns to the tank 134. An output shaft of the fan motor 136 is coupled to an air mover, shown as fan 138. The fan 138 is positioned adjacent the radiator 116 such that rotation of the fan motor 136 causes the fan 138 to move air through the radiator 116, cooling the coolant flowing therethrough. In the embodiment shown in FIG. 1, the fan 138 is positioned rearward of the radiator 116. In other embodiments, the fan 138 is positioned forward of the radiator 116 or positioned remotely from the radiator 116 and fluidly coupled to the radiator 116 through one or more ducts.

One or more control valves 140 are fluidly coupled between the hydraulic pump 132 and the fan motor 136. The control valves 140 are configured to regulate and/or control the flow of pressurized hydraulic fluid within the fan assembly 130. The control valves 140 may include check valves, relief valves, flow control valves, directional control valves, or other types of valves. The control valves 140 may be passively controlled (e.g., activated when a pressure overcomes a spring within the valve, etc.) or actively controlled (e.g., by an operator through a lever, switch, or dial, electronically by the controller 202, by a pneumatic or hydraulic pilot pressure controlled by the controller 202). By way of example, the fan assembly 130 may include flow control valves and/or pressure control valves that control the flow hydraulic fluid to the fan motor 136 and thereby control the speed and/or torque of the fan motor 136. By way of another example, the control valves 140 may include a pressure relief valve that extends across the inlet and the outlet of the fan motor 136 to reduce line pressure if the fan motor 136 is ever backdriven.

As shown in FIG. 2, the hydraulic pump 132 includes a displacement varying device, shown as actuator 142, and the fan motor 136 has a fixed displacement. By way of example, the hydraulic pump 132 may be an axial piston pump including a swash plate having a variable angle, and the actuator 142 may be used to adjust the angle of the swash plate. By varying the angle of the swash plate, the displacement of the hydraulic pump 132 may be varied. The actuator 142 may be electrically controlled (e.g., by applying a voltage to the actuator 142, etc.), pneumatically controlled (e.g., by applying pressurized air to the actuator 142), or hydraulically controlled (e.g., by applying a hydraulic pressure to the actuator 142). By way of example, the actuator 142 may include a biasing member (e.g., a compression spring, etc.) that biases the swash plate in a first direction and a hydraulic cylinder that acts on the swash plate in an opposing, second direction. The position of the swash plate may be varied by varying the hydraulic pressure supplied to the hydraulic cylinder. Because the hydraulic pump 132 has a variable displacement, the flow rate of hydraulic fluid leaving the hydraulic pump 132, and accordingly the speeds of the fan motor 136 and the fan 138, can be controlled using the actuator 142. In an alternative embodiment, the hydraulic pump 132 has a fixed displacement, and the fan motor 136 has a variable displacement controlled by an actuator 142. In another alternative embodiment, both the hydraulic pump 132 and the fan motor 136 have variable displacements controlled by actuators 142. In yet another embodiment, both the hydraulic pump 132 and the fan motor 136 have fixed displacements, and the control valves 140 adjust the flow rate of fluid between the hydraulic pump 132 and the fan motor 136 to control the speed of the fan 138. In each of these embodiments, the speed of the fan 138 can be adjusted to the optimize cooling and/or performance of the vehicle 10.

Referring to FIGS. 1 and 2, the vehicle 10 further includes a cab HVAC system including an air conditioning system 160. The air conditioning system 160 is configured to consume rotational mechanical energy and provide a supply of cooled air to the interior of the cab 40 for operator comfort. The air conditioning system 160 includes a refrigeration loop that circulates a refrigerant, such as R-134a. The air conditioning system 160 includes a compressor 162 that is driven by the engine 60 (e.g., directly, through a power take-off or driving belt, etc.). The compressor 162 is selectively coupled to the engine 60 by a clutch 164. The clutch 164 may be engaged automatically (e.g., by the controller 202, by an electrical switch controlled by an operator) when there is a demand for cooling within the cab 40. When engaged, the clutch 164 couples the engine 60 to the compressor 162. With the clutch 164 engaged, the compressor 162 compresses the refrigerant. The compressed refrigerant passes through a cooler, shown as condenser 166. The condenser 166 is positioned such that the fan 138 forces air therethrough, removing thermal energy from the refrigerant. In the embodiment shown in FIG. 2, the condenser 166 is positioned on the side of the fan 138 opposite the radiator 116. In other embodiments, the condenser 166 is positioned on the same side of the fan 138 as the radiator 116 or positioned remotely from the fan 138 and fluidly coupled to the fan 138 through one or more ducts.

The refrigerant moves from the condenser 166 through an expansion valve 168 and into an evaporator 170. In the evaporator 170, the refrigerant removes thermal energy from the surrounding environment, cooling air that is in contact with the evaporator 170. A fan, shown as HVAC blower 172, forces air through the evaporator 170, and this cooled air flows into the cab 40. The refrigerant then passes from the evaporator 170 back to the compressor 162.

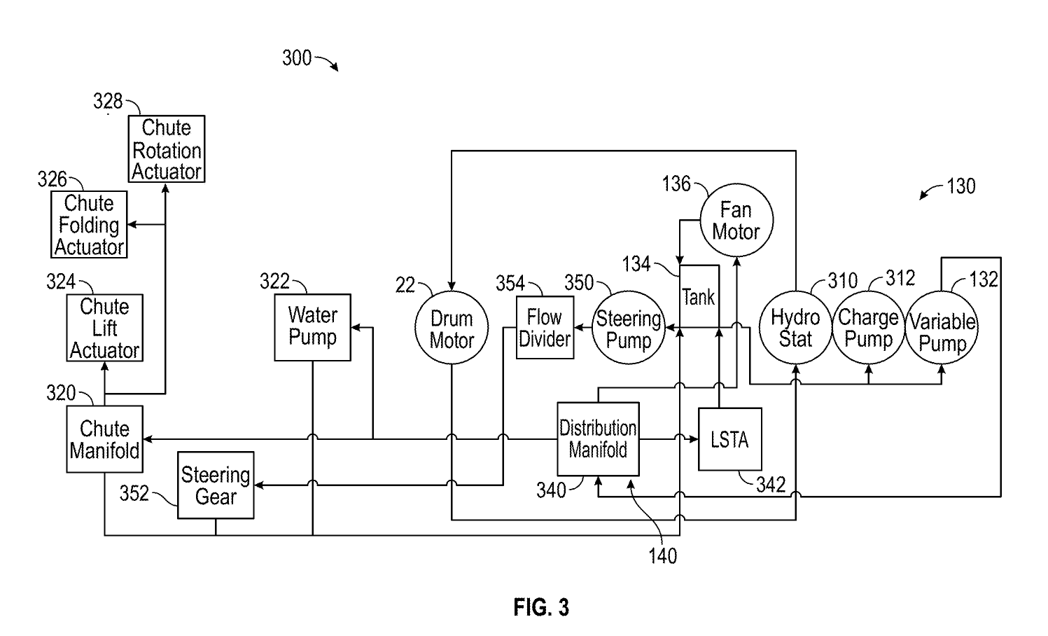

Referring to FIG. 3, a hydraulic circuit or hydraulic system 300 of the vehicle 10 is shown according to an exemplary embodiment. They hydraulic system 300 includes the fan assembly 130. The variable pump 132 is operably connected to a hydrostat device 310 that is configured to detect the presence of water as a prevention against drying out, overflow, or other undesirable water conditions. In some embodiments, a charge pump 312 is operably connected to the variable pump 132 to provide additional pump power to the variable pump 132.

In this embodiment, the variable pump 132 is a multi-function pump that supplies pressurized hydraulic fluid to the fan motor 136 and to other actuators. Specifically, the variable pump 132 is configured to provide pressurized hydraulic oil from the fluid tank 134 to power a chute manifold 320, the drum driver 22, a water pump 322, and the fan motor 136. The variable pump 132 provides pressurized hydraulic oil to power a chute lifting actuator 324, a chute folding actuator 326, and a chute rotation actuator 328 by way of (e.g., through) the chute manifold 320. The chute lifting actuator 324, the chute folding actuator 326, and the chute rotation actuator 328 are used to manipulate the discharge hopper 28 and/or the chute 29. In some embodiments, the control valves 140 include a distribution manifold 340 (e.g., actuator) that controls the flow of pressurized hydraulic fluid from the variable pump 132 to the chute manifold 320. In some embodiments, a load span tag axle (LSTA) 342 is powered by the variable pump 132, and the distribution manifold 340 controls the flow of fluid to the LSTA 342.

A separate steering pump 350 is coupled to a steering gear 352 and is configured to provide feedback regarding the steering speed (i.e., the rate at which the steering angle changes) and steering force (e.g., the force required to change or maintain the steering angle) to a steering wheel in the cab 40 that is physically operated by an operator. The steering pump 350 may be driven by the engine 60. A flow divider 354 is configured to control flow to the steering gear 352 and return excess or unnecessary pressurized hydraulic oil back to the fluid tank 134. Implementing a dedicated steering pump 350 and/or steering circuit prevents the steering feel and wheel speed of the concrete mixer truck 10 from being affected by operation of the variable pump 132.

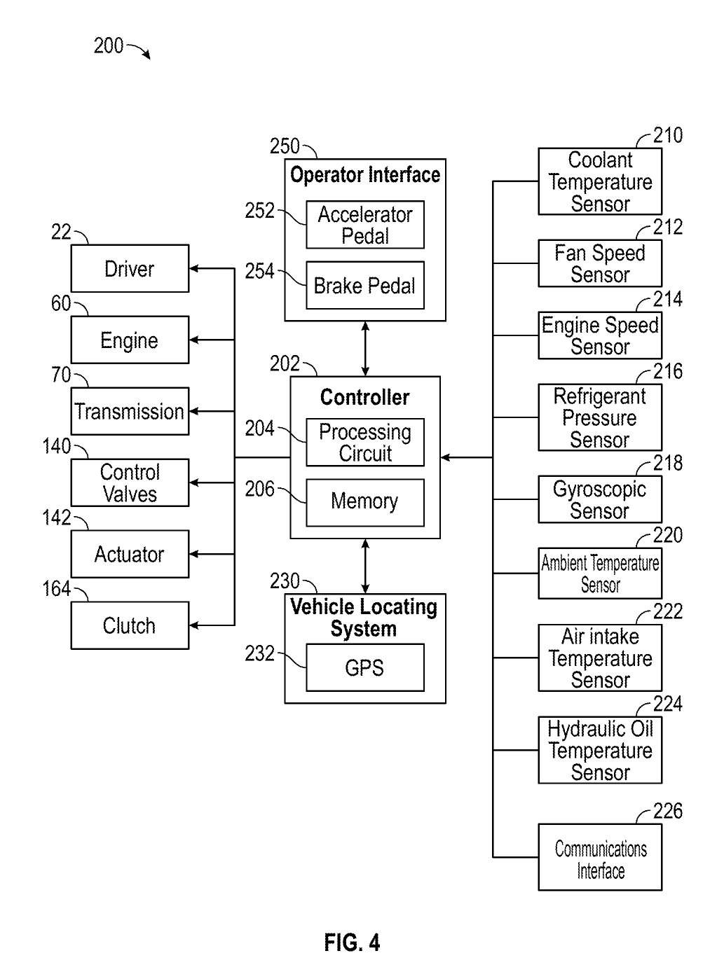

Referring to FIG. 4, the vehicle 10 includes a control system 200. The control system 200 includes a controller 202 configured to control operation of the vehicle 10. As shown in FIG. 4, the controller 202 is operatively coupled to and configured to control the engine 60 (e.g., the fuel or voltage supplied to the engine 60, etc.), the transmission 70 (e.g., shifting the transmission 70, etc.), the control valves 140, and the actuator 142. The controller 202 may additionally be operatively coupled to and configured to control the air conditioning system 160 (e.g., by engaging or disengaging the clutch 164). In some embodiments, the controller 202 is configured to control one or more implements that utilize pressurized hydraulic oil (e.g., chute lifting actuator 324, the driver 22, etc.). By way of example, the controller 202 may control the control valves 140 to control the flow of hydraulic fluid to such implements.

The controller 202 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. According to the exemplary embodiment shown in FIG. 4, the controller 202 includes a processing circuit 204 and a memory 206. The processing circuit 204 may include an ASIC, one or more FPGAs, a DSP, circuits containing one or more processing components, circuitry for supporting a microprocessor, a group of processing components, or other suitable electronic processing components. In some embodiments, the processing circuit 204 is configured to execute computer code stored in the memory 206 to facilitate the activities described herein. The memory 206 may be any volatile or non-volatile computer-readable storage medium capable of storing data or computer code relating to the activities described herein. According to an exemplary embodiment, the memory 206 includes computer code modules (e.g., executable code, object code, source code, script code, machine code, etc.) configured for execution by the processing circuit 204. The memory 206 includes various actuation profiles corresponding to modes of operation (e.g., for the engine 60, for the fan assembly 130, for the vehicle 10, etc.), according to an exemplary embodiment. In some embodiments, the controller 202 may represent a collection of processing devices (e.g., servers, data centers, etc.). In such cases, the processing circuit 204 represents the collective processors of the devices, and the memory 206 represents the collective storage devices of the devices.

Referring to FIG. 4, the controller 202 is operatively coupled to and configured to receive signals from one or more sensors. The control system 200 includes a temperature sensor, shown as coolant temperature sensor 210, configured to provide a signal or data indicative of the temperature of the coolant circulating within the coolant circuit 110. Accordingly, the coolant temperature sensor 210 provides an indication of the temperature of the engine 60. The control system 200 further includes a fan speed sensor 212 that provides a signal or data indicative of the rotational speed of the fan 138. The fan speed sensor 212 may include a sensor that senses rotation of the fan directly, such as an encoder or a magnetic sensor. Alternatively, the fan speed sensor 212 may include a flowmeter that senses the flow rate of hydraulic fluid provided to the fan motor 136. In such an embodiment, the controller 202 may be configured to use the displacement of the fan motor 136 and the flow rate to determine the speed of the fan 138. The fan speed sensor 212 may additionally or alternatively include a sensor configured to measure the position of the actuator 142. The controller 202 may be configured to use the position of the actuator 142 to determine the displacement of the hydraulic pump 132 and/or the fan motor 136 and use that displacement to determine the speed of the fan 138. The control system 200 further includes an engine speed sensor 214 that provides a signal or data indicative of the speed of the engine 60. The engine speed sensor 214 may include a sensor that senses rotation of the engine 60, such as an encoder or a magnetic sensor. The controller 202 may be configured to use the speed of the engine 60 when determining the speed of the fan 138. The control system 200 further includes a pressure sensor, shown as refrigerant pressure sensor 216, that is configured to provide a signal or data indicative of the pressure of the refrigerant at a location within the air conditioning system 160. The control system 200 further includes an angular orientation sensor or inclinometer, shown as gyroscopic sensor 218. The gyroscopic sensor 218 is configured to provide a signal or data indicative of the orientation of the vehicle 10 (e.g., the frame 30, etc.) with respect to the direction of gravity.

The control system 200 further includes a temperature sensor, shown as ambient temperature sensor 220, configured to provide a signal or data indicative of the temperature of the ambient air surrounding the vehicle 10. Accordingly, the ambient temperature sensor 220 provides an indication of the temperature of the air entering the engine 60 and the ease with which heat can be transferred from the vehicle 10 to the surrounding environment. Additionally or alternatively, the control system 200 includes a temperature sensor, shown as air intake temperature sensor 222, configured to provide a signal or data indicative of the temperature of the air entering the engine 60 immediately before or after the air enters the engine 60. The control system 200 further includes a temperature sensor, shown as hydraulic oil temperature sensor 224, configured to provide a signal or data indicative of the temperature of hydraulic oil within the vehicle 10. The hydraulic oil temperature sensor 224 may provide the temperature of the hydraulic oil that powers the fan motor 136 and the chute actuators, the temperature of the hydraulic oil that powers the steering gear 352, and/or another temperature of hydraulic oil. In some embodiments, this hydraulic oil is also cooled by the fan 138 (e.g., through a radiator).

The control system 200 further includes a communications interface 226 that facilitates communication (e.g., transfer of data) between the controller 202 and another device. By way of example, the communications interface 226 may facilitate communication between the controller 202 and one or more other vehicles in a fleet of vehicles. The communications interface 226 may communicate over a wired connection (e.g., Ethernet, USB, etc.) or a wireless connection (e.g., Bluetooth, Wi-Fi, over a cellular network, etc.). The communications interface 226 may communicate with the other device directly or through one or more intermediate devices.

In some embodiments, the control system 200 includes a positioning system, shown as vehicle locating system 230, that is configured to provide a signal or data indicative of the location of the vehicle 10. The vehicle locating system 230 may include a global positioning system (GPS) 232. The GPS 232 may be configured to connect to one or more external systems, such as satellites or wireless signal towers (e.g., towers that provide a communication network for cellular phones), that indicate the location of the vehicle 10 relative to the earth or another landmark. The controller 202 may utilize maps (e.g., stored in the memory 206, provided by the GPS 232 or another source, etc.) and the location provided by the GPS 232 to locate the vehicle 10 relative to a location of interest, such as a road, a city, a town, a natural feature, or a building.

The control system 200 further includes an operator interface 250 operatively coupled to the controller 202. The operator interface 250 may be configured to receive inputs from an operator. By way of example, the operator interface 250 may include touchscreens, cameras, microphones, buttons, switches, knobs, levers, or other operator input devices. The operator interface 250 may be configured to provide information to the operator. By way of example, the operator interface 250 may include screens (e.g., touchscreens, etc.), gauges, speakers, lights, or other output devices. As shown in FIG. 4, the operator interface 250 include a throttle demand input device or throttle input device, shown as accelerator pedal 252, and a brake input device or brake demand input device, shown as brake pedal 254. The operator may use the accelerator pedal 252 and the brake pedal 254 to control acceleration and deceleration of the vehicle 10, respectively. The operator interface 250 may be positioned inside the cab 40 and/or outside the cab 40.

The controller 202 is configured to control the speed of the fan 138 through control of the actuator 142. Through control of the speed of the fan 138, the controller 202 controls the rate of cooling of the radiator 116 and the condenser 166 and the load that the fan assembly 130 imparts on the engine 60. In a system where air is forced through a cooler (e.g., the radiator 116, the condenser 166) by a fan (e.g., the fan 138), the amount of thermal energy removed from the cooler is proportional to the air flow introduced by the fan. The air flow rate introduced by the fan is proportional to the speed of the fan. The fan load (i.e., the torque required to drive the fan) is proportional to the square of the speed of the fan. The system load (i.e., the power required to drive the fan) increases cubically with the speed of the fan. Specifically, the air flow rate, the fan load, and the system load are calculated as follows:

Air Flow Rate=k_{q}*N (1)

Fan Load=K_{tq}*N² (2)

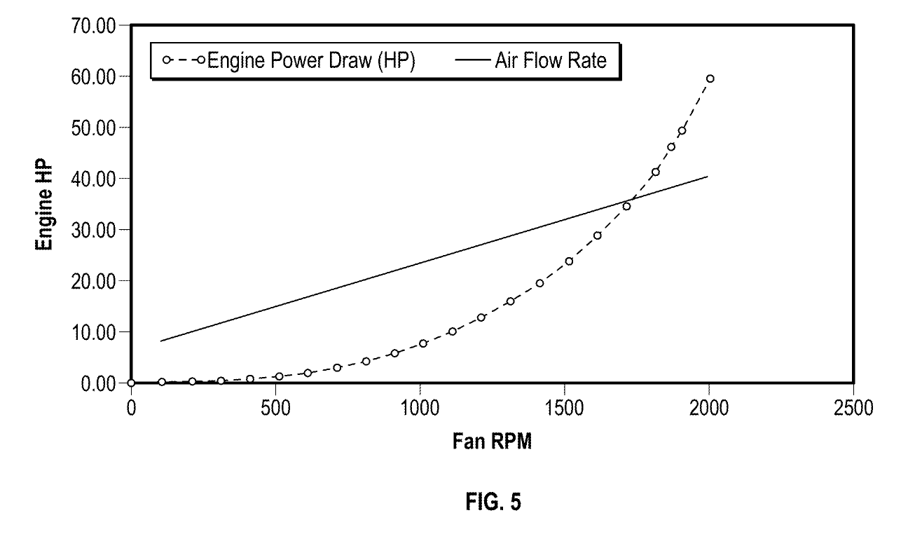

System Load=K_{pwr}*N³ (3)

Where N is the fan speed (e.g., in rpm) and k_{q}, K_{tq}, and K_{pwr} are coefficient parameters related to air flow rate, torque, and power consumption, respectively. The coefficient parameters k_{q}, K_{tq}, and K_{pwr} depend on certain system-specific factors, such as the dimensions and materials of fan and cooler used. FIG. 5 illustrates the rates of change of system load (measured as load on the engine) and air flow rate with respect to fan speed.

The use of a variable displacement pump and/or a variable displacement motor in the fan assembly 130 facilitates the fan 138 operating at any speed within a range (e.g., a range from 0 rpm to 2000 rpm) as desired. The maximum speed of this range is determined by the speed of the engine 60 and the displacements of the hydraulic pump 132 and fan motor 136. Accordingly, the controller 202 may control the speed of the fan 138 such that the fan 138 operates for long periods of time at a relatively low speed.

This type of control provides cooling far more efficiently than a traditional fan arrangement. Conventionally, a mechanical clutch is used to either engage or disengage a fan to an output of an engine. Accordingly, such a fan either runs at its maximum speed (e.g., at engine speed) or is nearly stationary. By way of example, knowing that cooling performance is proportional to air flow rate and using Equation 1, it can be determined that running a fan for a period of 20 minutes at 500 rpm removes a similar amount of thermal energy to running the fan for a period of 10 minutes at 1000 rpm. However, using Equation 3, it can be determined that running the fan for a period of 20 minutes at 500 rpm requires approximately 25% of the mechanical energy that is required to run the fan for a period of 10 minutes at 1000 rpm. A similar result can be reached when comparing running a fan for a period of 20 minutes at 500 rpm against running the fan for a period of 5 minutes at 2000 rpm. Both cases remove a similar amount of thermal energy, however, running the fan for a period of 20 minutes at 500 rpm requires only approximately 6.3% of the mechanical energy that is required to run the fan for a period of 5 minutes at 2000 rpm. Accordingly, by running the fan 138 for extended periods of time at relatively low speeds, the cooling system 100 can provide dramatically reduced energy requirements and increased fuel economy without compromising cooling performance. This type of control is not possible with a conventional clutch that can only be engaged or disengaged.

In some conventional cooling systems, variable speed mechanical clutches are utilized. These variable speed clutches vary the output speed of the clutch (e.g., the speed of the fan) relative to the input speed of the clutch (e.g., the speed of the engine) by controlling the frictional forces between different parts of the clutch and introducing slippage. This slippage produces a significant amount of energy loss due to friction. When the clutch is fully engaged, there is little to no energy loss due to slippage. With the clutch fully disengaged, the fan moves freely relative to the input portion of the clutch. The maximum energy loss occurs at partial engagement of the clutch. Specifically, at ⅔ of the full speed (i.e., the output portion of the clutch rotates at ⅔ the speed of the input portion) approximately 70% of the energy input into the clutch by the engine is lost. This generates large amounts of thermal energy that can damage components of the clutch (e.g., clutch discs, etc.). To minimize the number of clutch engagement cycles and increase the life of such clutches, control strategies are employed such as engaging the clutch at a very high temperature and keeping the clutch engaged until the coolant reaches a very low temperature or specifying a minimum clutch engagement time. However, these strategies further reduce efficiency and reduce the precision with which temperature can be controlled.

Due to the variable displacement of the hydraulic pump 132 and/or the fan motor 135, the fan assembly 130 experiences only minimal energy losses (e.g., due to the flowing of hydraulic fluid), and experiences no significant decrease in efficiency when operating the fan 138 at less than the maximum speed. Additionally, the variable displacement facilitates smooth transitioning between different speeds of the fan 138, eliminating the shock loading associated with engagement of a traditional mechanical clutch and thereby reducing component wear. The variable displacement also facilitates precise control over the temperature of coolant. The fan assembly 130 additionally facilitates flexibility when placing the radiator 116, the fan 138, and the condenser 166, as the fan 138 can be placed anywhere that allows hoses to extend between the fan motor 136 and the hydraulic pump 132. This facilitates placement of components in less crowded areas, improving cooling performance.

In some embodiments, the controller 202 controls (e.g., varies, sets, etc.) the speed of the fan 138 (i.e., a fan speed) based on one or more inputs. The inputs may include any telematics data available to the controller 202. The telematics data may include data from one or more sensors (e.g., the coolant temperature sensor 210, the fan speed sensor 212, the engine speed sensor 214, the refrigerant pressure sensor 216, the gyroscopic sensor 218, the ambient temperature sensor 220, the air intake temperature sensor 222, the hydraulic oil temperature sensor 224, etc.), the vehicle locating system 230, the operator interface 250, or from other sources. The telematics data may include quantitative data such as temperatures, pressures, speeds, and flow rates and/or qualitative data such as user settings and vehicle locations.

The telematics data may include data relating to the vehicle 10. Such data may include data provided by one or more of the sensors, the vehicle locating system 230, or the operator interface 250 onboard the vehicle 10. The telematics data may additionally or alternatively include data relating to another vehicle. Such telematics data may be measured or otherwise observed by a sensor or system of the other vehicle and provided to the vehicle 10 through the communications interface 226.

The telematics data may include current data and/or historical data. The current data may be measured in substantially real time. The historical data may include data that was measured or observed in the past and recorded (e.g., in the memory 206). The historical data may include data from multiple sources that is correlated in the memory 206. For example, the historical data may include various vehicle settings (e.g., the position of the actuator 142, a setting of a climate control system) and measurements (a fan speed, an engine speed, an ambient temperature, a position of the accelerator pedal 252, etc.) and the corresponding effect on one or more vehicle performance parameters (e.g., a coolant temperature).

The controller 202 may utilize the historical data to determine the target fan speed. By way of example, using the historical data, the controller 202 may train a neural network that relates the telematics data to a target fan speed. When training the neural network, the controller 202 may attempt to minimize the power consumed by the fan 138 while maintaining one or more quantities at a target level (e.g., the coolant temperature within a desired range, etc.). During operation, the controller 202 may utilize current telematics data and the trained neural network to determine the target fan speed.

The controller 202 may control the speed of the fan 138 based on a current coolant temperature determined using the coolant temperature sensor 210. Using the current coolant temperature and/or other inputs, the controller 202 determines a target fan speed for the fan 138. Using feedback from the fan speed sensor 212, the controller 202 determines a current speed of the fan 138. The controller 202 then controls the actuator 142 to minimize the difference between the current fan speed and the target fan speed. By way of example, the controller 202 may use the actuator 142 to increase the displacement of the hydraulic pump 132 when the current fan speed is less than the target fan speed or vice versa. Alternatively, the control system 200 may utilize open loop control of the fan speed. The controller 202 may store (e.g., in a lookup table in the memory 206) settings that correspond to certain fan speeds. By way of example, knowing the displacement and speed of the hydraulic pump 132 and the positions of the control valves 140, the controller 202 may be able to determine (e.g., estimate) the fan speed without using the fan speed sensor 212. These settings may be determined using historical telematics data from the vehicle 10 or from another similar vehicle.

In some embodiments, the controller 202 uses the actuator 142 to control the speed of the fan 138 to maintain the temperature of the coolant and/or the engine 60 within a temperature control range and/or near a target temperature. Using feedback from the coolant temperature sensor 210, the controller 202 determines a difference between the current coolant temperature and the temperature control range or the target temperature. The controller 202 may increase the target fan speed of the fan 138 as the difference increases (e.g., proportionally). The controller 202 may be configured to set the target fan speed of the fan 138 to zero (i.e., stop applying mechanical energy to the fan 138) or to a predefined low speed (e.g., 80 rpm, etc.) when the difference drops below a threshold. Alternatively, the controller 202 may be configured such that, once the difference drops below a threshold level, the controller 202 waits a predetermined period of time, then sets the target fan speed of the fan 138 to zero. The controller 202 may be tuned with an emphasis on running the fan 138 at the lowest possible speed for an extended period of time to increase the efficiency of the cooling system 100.

In other embodiments, the memory 206 stores a predefined map (e.g., a table of data points) that relates the current coolant temperature to the target fan speed of the fan 138. Accordingly, the controller 202 may determine the target fan speed of the fan 138 by interpolating the current coolant temperature within the predefined map. In some embodiments, the map is defined such that the controller 202 sets the target fan speed of the fan 138 to zero when the coolant temperature drops below a threshold temperature. Alternatively, the controller 202 may be configured such that, once the coolant temperature drops below a threshold temperature, the controller 202 waits a predetermined length of time, then sets the target fan speed of the fan 138 to zero. The controller 202 may be tuned with an emphasis on running the fan 138 at the lowest possible speed for an extended period of time to increase the efficiency of the cooling system 100.

In other embodiments, the target fan speed of the fan 138 is based on a current temperature of another fluid of the vehicle 10 that is cooled by the fan 138. By way of example, the target fan speed of the fan 138 may be based on a current temperature of engine oil, transmission oil, or hydraulic oil (e.g., the hydraulic fluid circulating through the fan assembly 130, hydraulic fluid used to drive the driver 22, etc.). The temperature of the hydraulic oil may be determined using the hydraulic oil temperature sensor 224. In such embodiments, the control system 200 may include additional temperature sensors to facilitate determining temperatures of such fluids. The temperature of each fluid may correspond to a target fan speed (e.g., based on a corresponding predefined map). The controller 202 may set the target fan speed to be the highest target fan speed specified by any of the predefined maps. By way of example, if the target fan speed based on the coolant temperature is 1700 rpm and the target fan speed based on the hydraulic oil temperature is 1800 rpm, the controller 202 may set the target fan speed to 1800 rpm.

In some embodiments, the controller 202 is configured to vary the target fan speed of the fan 138 based on the loading of the vehicle 10. When a temporary demand for increased output of the engine 60 is detected (e.g., when accelerating, when climbing a slope, when merging on the highway, etc.), the controller 202 is configured to reduce the target fan speed of the fan 138. This reduces the load on the engine 60 and facilitates providing additional output power (e.g., 40 horsepower) to other outputs of the engine 60 (e.g., to drive the front tractive assembly 50 or the rear tractive assemblies 52, to drive a power take-off function, etc.) that would otherwise be used by the fan assembly 130. Alternatively, when a reduced demand for output of the engine 60 is detected, the controller 202 may be configured to increase the target fan speed of the fan 138. This increases cooling during periods when the engine 60 is not otherwise loaded.

The controller 202 may be configured to use a variety of inputs to detect a demand for increased output of the engine 60 or a reduced demand for output of the engine 60. The controller 202 may be configured to interpret an increased throttle demand from a user (e.g., the accelerator pedal 252 being depressed beyond a first threshold angle) as a demand for increased output of the engine 60. The controller 202 may be configured to interpret a reduced throttle demand from a user (e.g., the accelerator pedal 252 being released above a second threshold angle) as a reduced demand for output of the engine 60. The controller 202 may be configured to interpret an increased brake demand from a user (e.g., the brake pedal 254 being depressed below a threshold angle) as a reduced demand for output of the engine 60. The controller 202 may be configured to interpret the speed of the engine 60 (e.g., as measured by the engine speed sensor 214) exceeding a first threshold speed as a demand for increased output of the engine 60. The controller 202 may be configured to interpret the speed of the engine 60 falling below a second threshold speed as a reduced demand for output of the engine 60. In some embodiments, the operator interface 250 includes one or more buttons, switches, or other input devices that, when engaged, indicate a demand for increased output of the engine 60 and/or a reduced demand for output of the engine 60.

In some embodiments, the controller 202 is configured to determine when the vehicle 10 is traveling on a slope (e.g., an incline, a decline). The controller 202 may interpret the vehicle 10 traveling up a slope as a demand for increased output of the engine 60. The controller 202 may interpret the vehicle 10 traveling down a slope as a reduced demand for output of the engine 60. In some embodiments, the controller 202 uses the gyroscopic sensor 218 to determine when the vehicle 10 is traveling up or down a slope. Specifically, the controller 202 may be configured to determine that the vehicle 10 is traveling up a slope when an angle between the frame 30 and the direction of gravity is greater than a first predetermined threshold angle. The controller 202 may be configured to determine that the vehicle 10 is traveling down a slope when the angle between the frame 30 and the direction of gravity is less than a second predetermined threshold angle. In other embodiments, the controller 202 uses the GPS 232 to determine when the vehicle is traveling up or down a slope. By way of example, the memory 206 may store data associating different locations on various roads with the angle of incline or grade of the road at that location. The controller 202 may then compare the location of the vehicle 10 provided by the GPS 232 with the stored data to determine the angle of incline or grade of the road where the vehicle 10 is currently located. If the angle of incline or grade has higher than a threshold magnitude, then the controller 202 may determine that the vehicle 10 is traveling up or down a slope. The controller 202 may store the location data from the GPS 232 over time in the memory 206, and use historical data to determine if the vehicle 10 is traveling up the slope or down the slope. In yet other embodiments, the controller 202 may receive a signal indicative of an elevation of the vehicle 10 (e.g., from the GPS 232, from a dedicated elevation sensor, etc.). The controller 202 may store elevation data over time in the memory 206 and use the rate of change of elevation to determine if the vehicle 10 is traveling up the slope or down the slope.

Upon detecting a demand for increased output of the engine 60, the controller 202 may be configured to reduce the target fan speed of the fan 138. The controller 202 may reduce the target fan speed by a fixed amount (e.g., 200 rpm) or to a specific speed (e.g., 500 rpm). The controller 202 may be configured to adjust the magnitude of the target fan speed reduction when the current coolant temperature is above a threshold temperature. By way of example, the controller 202 may reduce the target fan speed by a lesser amount or not reduce the target fan speed at all, resulting in a higher target fan speed. Upon detecting a reduced demand for output of the engine 60, the controller 202 may be configured to increase the target fan speed of the fan 138. The controller 202 may increase the target fan speed by a fixed amount (e.g., 200 rpm) or to a specific speed (e.g., 2000 rpm). The controller 202 may be configured to adjust a magnitude of the target fan speed increase when the current coolant temperature is below a threshold temperature. By way of example, the controller 202 may increase the target fan speed by a lesser amount or not increase the target fan speed at all, resulting in a lower target fan speed.

In some embodiments, the controller 202 is configured to adjust the target fan speed of the fan 138 based on a loading or operational state (e.g., on, off, at 50% capacity, etc.) of the air conditioning system 160. The controller 202 may be configured to vary the target fan speed of the fan 138 based on engagement of the clutch 164 (e.g., when the controller 202 engages the clutch 164, when the controller 202 receives an operator input through the operator interface 250 that indicates a desire for cooling in the cab 40, etc.). By way of example, the controller 202 may be configured to increase the target fan speed of the fan 138 when the clutch 164 is engaged to further cool the condenser 166. By way of another example, the controller 202 may be configured to temporarily decrease the target fan speed of the fan 138 when the clutch 164 is engaged to reduce the load on the engine 60 and improve acceleration. The controller 202 may be configured to vary the target fan speed of the fan 138 based on the pressure of the refrigerant (e.g., as determined using the refrigerant pressure sensor 216). By way of example, the controller 202 may increase the target fan speed of the fan 138 as the pressure of the refrigerant increases. By way of another example, the controller 202 may increase the target fan speed of the fan 138 when the pressure of the refrigerant exceeds a threshold pressure. Alternatively, the refrigerant pressure sensor 216 may be replaced with a sensor that provides a signal indicative of a temperature of the refrigerant, and the temperature of the refrigerant may be used when controlling the fan 138 instead of the pressure of the refrigerant.

In some embodiments, the controller 202 is configured to reduce the target fan speed of the fan 138 to reduce a noise level associated with operation of the fan 138. Such a reduction in noise level is desirable in certain environments, such as residential areas or job sites, where people would be exposed to the noise. Such a reduction may facilitate verbal communication and provide a more pleasant working or living environment. The controller 202 may reduce the target fan speed by a fixed amount (e.g., 200 rpm) or to a specific speed (e.g., 500 rpm). The controller 202 may be configured to adjust the magnitude of the target fan speed reduction when the current coolant temperature is above a threshold temperature. By way of example, the controller 202 may reduce the target fan speed by a lesser amount or not reduce the target fan speed at all, resulting in a higher target fan speed. In some embodiments the reduction in target fan speed is controlled manually by an operator. By way of example, an operator may manually activate and/or deactivate the reduction in target fan speed by interacting with a button of the operator interface 250.

In other embodiments, the controller 202 is configured to automatically vary the target fan speed based on a location of the vehicle. The controller 202 may be configured to use information from the GPS 232 to determine a location of the vehicle 10. The controller 202 may be configured to automatically reduce the target fan speed of the fan 138 when the vehicle 10 is located in certain areas. By way of example, the controller 202 may classify certain areas (e.g., residential areas, job sites or construction sites where the vehicle 10 operates, a garage where the vehicle 10 is stored, etc.) as “low noise areas” or “reduced noise areas” where it is desired to reduce the noise level of the fan 138. The locations of these low noise areas may be stored in memory 206. The controller 202 may compare the current location (e.g., as provided by the GPS) with the locations of the low noise areas stored in the memory to determine whether or not the vehicle is in a low noise area. The low noise areas may be defined by certain roads (e.g., the vehicle 10 is determined to be in a low noise area when traveling on certain roads). Alternatively, the low noise areas may be defined by coordinates, such as global coordinates (e.g., latitude and longitude). Accordingly, an operator or user may designate an area (e.g., using the operator interface 250) where it is desired to operate the vehicle 10 at a reduced noise level, and the controller 202 may automatically reduce the target fan speed when traveling in a low noise area. Automatically determining when to reduce the target fan speed requires less effort from the operator and prevents an operator from forgetting to reduce the target fan speed when entering a low noise area.

In some embodiments, the controller 202 is configured to determine a distance between the vehicle 10 and one or more other vehicles. The controller 202 may utilize the vehicle locating system 230 to determine the location of the vehicle 10. The controller 202 may receive (e.g., through the communications interface 226) telematics data (e.g., coordinates) from another vehicle indicating the location of the other vehicle. Using this telematics data, the controller 202 may determine the relative distance between the vehicle 10 and the other vehicle. When the distance between the vehicle 10 and the other vehicle is below a threshold distance, the controller 202 may determine that the vehicle 10 is in close proximity to the other vehicle. The close proximity of the vehicles may indicate that the vehicles are present at a garage, job site, or other reduced noise area. Accordingly, the controller 202 may reduce the target fan speed of the fan 138 in response to a determination that the distance between the vehicle 10 and another vehicle in communication with the vehicle 10 is less than a threshold distance. Alternatively, the controller 202 may reduce the target fan speed of the fan 138 in response to a determination that the distances between the vehicle 10 and a threshold number of other vehicles (e.g., two other vehicles, three other vehicles, etc.) are below the threshold distance.

In some embodiments, the controller 202 is configured to vary the target fan speed of the fan 138 based on a speed of the vehicle 10. In some embodiments, the controller 202 is configured to utilize data from the GPS 232 to determine a current vehicle speed. In other embodiments, the controller 202 is configured to utilize data from another source to determine the current vehicle speed (e.g., an encoder attached to a driveshaft, the engine speed sensor 214 in combination with data from another sensor that provides the current gear ratio of the transmission 70, etc.). In some embodiments, the controller 202 is configured to reduce the speed of the fan 138 as the current vehicle speed increases. Additionally or alternatively, the controller 202 may be configured to increase the speed of the fan 138 as the current vehicle speed decreases. An increase in vehicle speed may indicate a larger loading on the engine 60 (e.g., due to increased air resistance), and reducing the fan speed may reduce the overall load on the engine 60. Additionally, at higher speeds, the cooling system 100 may take advantage of additional passive cooling from the vehicle 10 moving through the surrounding air. In some embodiments, the controller 202 is configured to increase the speed of the fan 138 as the current vehicle speed increases. Additionally or alternatively, the controller 202 may be configured to reduce the speed of the fan 138 as the current vehicle speed decreases. In some embodiments, the controller 202 increases the target fan speed until the vehicle speed reaches a first threshold speed, then reduces the target fan speed as the speed of the vehicle 10 continues to increase or decrease.

In some embodiments, the controller 202 is configured to vary the target fan speed based on an ambient temperature of the air surrounding the vehicle 10. In some embodiments, the controller is configured to utilize data from the ambient temperature sensor 220 to determine the ambient temperature. In other embodiments, the controller 202 is configured to utilize data from another source (e.g., weather data, data from the air intake temperature sensor 222, etc.) to determine (e.g., estimate) the ambient temperature. In some embodiments, the controller 202 is configured to increase the speed of the fan 138 as the ambient temperature increases. Additionally or alternatively, the controller 202 may be configured to reduce the target fan speed of the fan 138 as the ambient temperature decreases. An increase in ambient temperature may indicate that it will be more difficult to transfer thermal energy from the vehicle 10 to the surrounding atmosphere. Accordingly, increasing the target fan speed may help to maintain a desired level of cooling performance as the ambient temperature increases.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claim.

1. A vehicle, including:
a chassis;
a plurality of tractive elements configured to support the chassis;
a primary driver configured to output mechanical energy to at least one of the tractive elements to drive the vehicle;
a coolant circuit, comprising:
a thermal energy interface configured to facilitate transfer of thermal energy from the primary driver to coolant; and
a radiator fluidly coupled to the thermal energy interface and configured to receive the coolant;
a fan assembly, comprising:
a hydraulic pump coupled to the primary driver;
a hydraulic motor fluidly coupled to the hydraulic pump;
a fan coupled to the hydraulic motor and configured to provide air flow to the radiator; and
an actuator configured to vary a displacement of at least one of the hydraulic pump and the hydraulic motor; and
a controller operatively coupled to the actuator and configured to control the actuator to vary a speed of the fan based on telematics data.

2. The vehicle of claim 1, wherein the telematics data includes data relating to a location of the vehicle, and wherein the controller is configured to automatically vary the speed of the fan based on the location of the vehicle.

3. The vehicle of claim 2, wherein the controller is configured to determine whether or not the location of the vehicle is within a reduced noise area, and wherein the controller is configured to reduce a speed of the fan in response to a determination that the vehicle is within the reduced noise area.

4. The vehicle of claim 3, wherein the reduced noise area is specified by a user.

5. The vehicle of claim 4, wherein the controller is operatively coupled to a global positioning system (GPS), and wherein the GPS provides the provides the data relating to the location of the vehicle.

6. The vehicle of claim 5, wherein the reduced noise area is at least one of a construction site, a job site, a residential area, and a garage.

7. The vehicle of claim 1, wherein the vehicle is a first vehicle, wherein the telematics data includes data relating to a distance between the first vehicle and a second vehicle in communication with the first vehicle, and wherein the controller is configured to reduce the speed of the fan in response to a determination that the distance between the first vehicle and the second vehicle is less than a threshold distance.

8. The vehicle of claim 1, wherein the telematics data includes data relating to a load of the primary driver, and wherein the controller is configured to reduce the speed of the fan in response to an indication that the load of the primary driver has increased.

9. The vehicle of claim 8, wherein the data relating to the load of the primary driver includes a throttle demand from a user, wherein the controller is configured to decrease the speed of the fan in response to an increased throttle demand from the user.

10. The vehicle of claim 8, wherein the data relating to the load of the primary driver includes a brake demand from a user, and wherein the controller is configured to increase the speed of the fan in response to an increased brake demand from the user.

11. The vehicle of claim 1, wherein the telematics data includes data relating to an ambient temperature of air surrounding the vehicle, and wherein the controller is configured to vary the speed of the fan based on the ambient temperature.

12. The vehicle of claim 1, wherein the vehicle is a first vehicle, wherein the first vehicle is in communication with a second vehicle, and wherein the telematics data includes data from a sensor of the first vehicle and data from a sensor of the second vehicle.

13. The vehicle of claim 1, further comprising an air conditioning system, the air conditioning system comprising:
a compressor coupled to the primary driver and configured to compress refrigerant;
a condenser fluidly coupled to the compressor and configured to receive the air flow from the fan; and
an evaporator fluidly coupled to the compressor and configured to transfer thermal energy to the refrigerant,
wherein the telematics data includes data relating to a loading of the air conditioning system, and wherein the controller is configured to vary the speed of the fan based the loading of the air conditioning system.

14. A fan assembly for a vehicle, comprising:
a hydraulic pump configured to be coupled to a primary driver of the vehicle;
a hydraulic motor fluidly coupled to the hydraulic pump;
a fan coupled to the hydraulic motor and configured to provide air flow to a radiator of the vehicle;
an actuator configured to vary at least one of (a) a flow rate of fluid to the hydraulic motor and (b) a displacement at of the hydraulic motor; and
a controller operatively coupled to the actuator and configured to control the actuator to vary a speed of the fan, wherein the controller is configured to receive data relating to a location of the vehicle, and wherein the controller is configured to control the speed of the fan based on the location of the vehicle.

15. The fan assembly of claim 14, wherein the controller is configured to determine whether or not the location of the vehicle is within a reduced noise area, and wherein the controller is configured to reduce a speed of the fan in response to a determination that the vehicle is within the reduced noise area.

16. The vehicle of claim 15, wherein the controller is configured to receive telematics data relating to a load of the primary driver, and wherein the controller is configured to reduce the speed of the fan in response to an indication that the load of the primary driver has increased.

17. The vehicle of claim 15, wherein the controller is configured to receive telematics data relating to an ambient temperature of air surrounding the vehicle, and wherein the controller is configured to vary the speed of the fan based on the ambient temperature.

18. The vehicle of claim 15, wherein the controller is configured to receive telematics data relating to a loading of an air conditioning system of the vehicle, and wherein the controller is configured to vary the speed of the fan based the loading of the air conditioning system.

19. The vehicle of claim 15, wherein the vehicle is a first vehicle, wherein the controller is in communication with a second vehicle, and wherein the controller is configured to vary the speed of the fan based on data from a sensor of the first vehicle and data from a sensor of the second vehicle.

20. A method of cooling a vehicle, comprising:
receiving, from a GPS, data relating to a location of the vehicle;
determining, based on the data from the GPS, whether or not the vehicle is in a reduced noise area;
in response to a determination that the vehicle is in the reduced noise area, operating a motor of the vehicle at a first speed; and
in response to a determination that the vehicle is not in the reduced noise area, operating the motor of the vehicle at a second speed greater than the first speed,
—wherein the motor is coupled to a fan such that rotation of the motor causes the fan to force air toward a radiator of the vehicle.
